(19) United States
(12) Patent Application Publication
(10) Pub. No.: US 2023/0235118 A1
(43) Pub. Date: Jul. 27, 2023

(54) THERMOPLASTIC RESIN AND OPTICAL MEMBER CONTAINING SAME

(71) Applicant: TEIJIN LIMITED, Osaka (JP)

(72) Inventors: Keisuke SATO, Osaka (JP); Takatsune YANAGIDA, Osaka (JP); Yasuhiko TOMONARI, Osaka (JP); Ryota MANO, Osaka (JP)

(73) Assignee: TEIJIN LIMITED, Osaka (JP)

(21) Appl. No.: 18/010,898

(22) PCT Filed: May 31, 2021
(86) PCT No.: PCT/JP2021/020741

§ 371 Date: Dec. 16, 2022

(30) Foreign Application Priority Data
Jun. 30, 2020 (JP) 2020-112992

(51) Int. Cl. C08G 64/16

(52) U.S. Cl. CPC C08G 64/1608

(57) ABSTRACT

The purpose of the present invention is to provide a thermoplastic resin far an optical lens. In order to enable an optical lens designer to use a variety of lenses, the thermoplastic resin should have a low refractive index, a low Abbe number and a water absorption rate similar to that of a polycarbonate resin. The present invention relates to a thermoplastic resin which contains repeating units represented by formula (1), formula (2) and formula (3) and which has a refractive index of 1.510-1.570. In formula (I), R₁, R₂, R₃ and R₄ are each independently a hydrogen atom or a hydrocarbon group having 1-10 carbon atoms. In formula (3), n is 1-8, R moieties are each independently selected from among a hydrogen atom or an alkyl group having 1-3 carbon atoms, and R₅ and R₆ are each independently a hydrogen atom or a hydrocarbon group having 1-10 carbon atoms.

### FIELD

The present invention relates to a novel thermoplastic resin, and an optical member formed using the same, in particular, an optical lens.

### BACKGROUND

Optical glass or transparent optical resin is used as a material for optical elements used in various cameras such as cameras, film-integrated cameras, and video cameras, and optical systems such as sensing cameras. Optical glass is excellent in heat resistance, transparency, dimensional stability, and chemical resistance and there are many types of materials having various refractive indexes and Abbe numbers. However, optical glass has problems in terms of high material cost, poor moldability, and low productivity. In particular, the processing of an aspherical lens used for aberration correction requires extremely advanced technology and high cost, which poses a major obstacle for practical use.

Optical lenses composed of a transparent optical resin, in particular, a transparent thermoplastic resin, are advantageous in that they can be mass-produced by injection molding and aspherical lenses can be easily manufactured, and they are currently used as camera lenses. Examples thereof include polycarbonates composed of bisphenol A, polystyrene, poly-4-methylpentene, polymethyl methacrylate, and amorphous polyolefin.

However, when a transparent optical resin is used in an optical lens, since transparency, heat resistance, and low birefringence are also required in addition to the refractive index and Abbe number, there is a weakness in that the usage is limited by the property balance of the resin. For example, in terms of weaknesses, polystyrene has low heat resistance and high birefringence, poly-4-methylpentene has low heat resistance, polymethyl methacrylate has a low glass transition temperature and low heat resistance, and polycarbonates composed of bisphenol A have high birefringence, and thus their uses are limited.

In the designing of optical lenses, a method of correcting aberration and chromatic aberration by combining and using a plurality of lenses having different refractive indexes and Abbe numbers is known. For example, aberration and chromatic aberration are corrected by combining a cycloolefin resin lens having a relatively low refractive index and a high Abbe number with a polycarbonate resin lens composed of bisphenol A having a high refractive index and a low Abbe number. However, a difference in water absorption between a cycloolefin resin and a polycarbonate resin causes a difference in water absorption expansion rate, and when lenses of both of the resins are combined to form a lens unit, a difference in size between the lenses occurs when water is absorbed in the usage environment of a smartphone or the like, whereby the performance of the lenses is impaired.

Patent Literature 1 reports a polycarbonate resin having a low refractive index and a high Abbe number using decahydro-1,4:5,8-dimethanonaphthalenediol (D-NDM), which exhibits the same level of water absorption as a polycarbonate resin having a high refractive index and a low Abbe number, and by combining these, the loss of lens performance due to difference in water absorption expansion coefficient is mitigated.

### CITATION LIST

### Patent Literature

[PTL 1] WO 2017/175693

### SUMMARY

### Technical Problem

In recent years, along with the expansion of the optical performance requirements and the expansion of designer design concepts due to the expansion of the use of optical units, the optical design of optical lenses is not limited to the combinations of relatively high refractive index, low Abbe number resin lenses and low refractive index, high Abbe number resin lenses, as described above, but combinations with low refractive index, low Abbe number resin lenses are also required.

Furthermore, designers can adopt a resin for optical lenses only if the resin is suitable in terms of not only refractive index and Abbe number, but heat resistance, birefringence, and a small difference in water absorption expansion coefficient with the above-mentioned resins.

Thus, an object of the present invention is to provide a thermoplastic resin far an optical lens which has a low refractive index, a low Abbe number, and a water absorption rate similar to that of polycarbonate resins, in order for the designers of optical lenses to apply the same to various types of lenses.

### Solution to Problem

The present inventors have found that the above problems can be solved by the present invention, which has the following aspects.

### Aspect 1

A thermoplastic resin containing repeating units represented by formula (1), formula (2), and formula (3), and having a refractive index of 1.510 to 1,570:

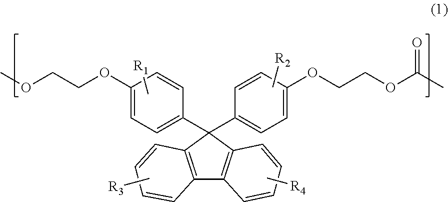

where R₁, R₂R₃, and R₄ each independently represent a hydrogen atom or a C₁₋₁₀ hydrocarbon group;

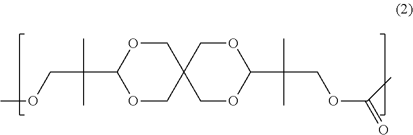

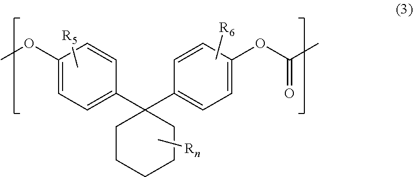

where n is in the range of 1 to 8, each R is independently selected from a hydrogen atom and a C₁₋₃ alkyl group, R₅ and R₆ each independently represent a hydrogen atom or a C₁₋₁₀ hydrocarbon group.

### Aspect 2

The thermoplastic resin according to Aspect 1, having an Abbe number of 32.0 to 40.0.

### Aspect 3

The thermoplastic resin according to any one of Aspects 1 and 2, having a saturated water absorption rate of 0.1% to 0.7%.

### Aspect 4

The thermoplastic resin according to any one of Aspects 1 to 3, having a glass transition temperature of 130° C. to 160° C.

### Aspect 5

The thermoplastic resin according to any one of Aspects 1 to 4, having an orientation birefringence of 6×10⁻³ or less.

### Aspect 6

The thermoplastic resin according to any one Aspects 1 to 5, wherein the repeating units of formula (1) are contained at 1 mol % to 40 mol %.

### Aspect 7

The thermoplastic resin according to any one of Aspects 1 to 6, wherein the repeating units of formula (2) are contained at 30 mol % to 60 mol %.

### Aspect 8

The thermoplastic resin according to any one of Aspects 1 to 7, wherein the repeating units of formula (3) are contained at 20 mol % to 50 mol %.

### Aspect 9

An optical member, comprising the thermoplastic resin according to any one of Aspects 1 to 8.

### DESCRIPTION OF EMBODIMENTS

The embodiments of the present invention will be described in detail below. However, the present invention is not limited thereto, and various changes can be made within a scope which does not deviate from the spirit thereof.

### Thermoplastic Resin

The thermoplastic resin of the present invention contains repeating units represented by formula (1), formula (2), and formula (3) above. The refractive index thereof is 1,510 to 1.570.

A repeating unit structure containing a polycyclic skeleton, such as D-NDM, described in Prior Art Literature 1, has a high atomic density per unit volume, and has characteristics of a high refractive index and a high Abbe number. However, due to the presence of the repeating unit structure containing the spiro ring structure of the formula (2) above and the cyclohexylidene bisphenol skeleton of the formula (3) above of the present invention, the atomic density per unit volume is low, resulting in a low refractive index and a low Abbe number. Furthermore, while formulas (2) and (3) above have positive birefringence, formula (1) above having a cardo structure has negative birefringence, whereby they, when combined, can achieve a low refractive index, a low Abbe number, and a low orientation birefringence.

### Thermoplastic Resin Structure

In formula (1) above, R₁, R₂, R₃, and R₄ each independently represent a hydrogen atom or a C₁₋₁₀ hydrocarbon group, and examples of the hydrocarbon group include an alkyl group, a cycloalkyl group, and an aryl group.

Examples of the alkyl group include a methyl group, ethyl group, propyl group, isopropyl group, butyl group, and t-butyl group, and a methyl group or an ethyl group is preferable.

Examples of cycloalkyl groups include a cyclopropyl group, cyclobutyl group, cyclopentyl group, cyclohexyl group, and bicyclo[1.1.1]pentanyl group.

Examples of aryl groups include a phenyl group, a tolyl group, a naphthyl group, and a xylyl group, and a phenyl group is preferable.

R₁ to R₄ are preferably each independently a hydrogen atom, a methyl group, or a phenyl group, and more preferably a hydrogen atom or a phenyl group, and R₁ and R₂ are each independently a hydrogen at or a phenyl group, and R₃ and R₄ are further preferably a hydrogen atom.

Formulas (2) and (3) above have positive birefringence, whereas formula (1) above having a cardo structure has negative birefringence. In the above case, the introduction amount of formula (1) can be increased without significantly increasing the refractive index, whereby a low refractive index and a low orientation birefringence can be achieved.

The repeating units represented by formula (1) above are preferably repeating units derived from 9,9-bis(4-(hydroxyethoxy)phenyl)fluorene (hereinafter sometimes referred to as BPEF) and 9,9-bis(4-(hydroxyethoxy)-3-phenylphenyl)fluorene and are more preferably repeating units derived from 9,9-bis(4-(hydroxyethoxy)phenyl)fluorene.

The thermoplastic resin of the present invention may contain 1 mol % or more, 5 mol % or more, 10 mol % or more, 12 mol % or more, 15 mol % or more, 20 mol % or more, 25 mol % or more, or 30 mol %, or more of repeating units represented by formula (1) above, and may contain 40 mol % or less, 35 mol % or less, 30 mol % or less, 25 mol % or less, 20 mol % or less, 15 mol % or less, or 10 mol % or less of repeating units represented by formula (1) above. The thermoplastic resin of the present invention can contain preferably 1 mol % to 40 mol %, more preferably 5 mol % to 35 mol %, further preferably 10 mol % to 35 mol %, particularly preferably 12 mol % to 35 mol %, and most preferably 15 mol % to 35 mol % of the repeating units of formula (1) above.

By including the repeating units of formula (1) at the upper limit or less, a low refractive index can be achieved, and by including the repeating units of formula (1) at the lower limit or higher, a low birefringence and a high heat resistance can be achieved.

The repeating units represented by formula (2) above are repeating units derived from 3,9-b bis(2-hydroxy-1,1-dimethylethyl)-2,4,8,10-tetraoxaspiro (5.5)undecane (hereinafter sometimes referred to as SPG).

The thermoplastic resin of the present invention may contain 25 mol % or more, 30 mol % or more, 35 mol % or more, 40 mol % or more, 45 mol % or more, or 50 mol % or more of repeating units represented by formula (2) above, and may contain 60 mol % or less, 55 mol % or less, 50 mol % or less, 45 mol %, or less, or 40 mol % or less of repeating units represented by formula (2) above. The thermoplastic resin of the present invention can contain preferably 25 mol % to 60 mol %, more preferably 30 mol % to 60 mol %, further preferably mol % to 55 mol %, and particularly preferably 30 mol % to 50 mol % of the repeating units of formula (2) above.

By including the repeating units of formula (2) at the upper limit or less, high heat resistance can be achieved, and by including the repeating units of formula (2) at the lower limit or higher, a low refractive index and a low Abbe number can be achieved.

n in formula (3) above represents a range of 1 to 8, preferably 1 to 5, more preferably 1 to 3, and further preferably 3. Each R independently represents a hydrogen atom or a C₁₋₃ alkyl group, preferably a methyl group or an ethyl group, and more preferably a methyl group. R₅ and R₆ each independently represent a hydrogen atom or a C₁₋₁₀ hydrocarbon group, and examples of the hydrocarbon group include an alkyl group, a cycloalkyl group, and an aryl group.

Examples of the alkyl group include a methyl group, ethyl group, propyl group, isopropyl group, butyl group, and t-butyl group, and a methyl group or ethyl group is preferable.

Examples of the cycloalkyl group include a cyclopropyl group, cyclobutyl group, cyclopentyl group, cyclohexyl group, and bicyclo[1.1.1]pentanyl group.

Examples of the aryl group include a phenyl group, tolyl group, naphthyl group, and xylyl group, and a phenyl group is preferable.

R₅ and R₆ are preferably each independently a hydrogen atom, a methyl group, or a phenyl group, more preferably a hydrogen atom or a phenyl group, and further preferably a hydrogen atom.

When the substituents of R are as described above, heat resistance can be further increased, and when the substituents of R₅ and R₆ are as described above, the introduction amount of formula (3) above can be increased without significantly increasing the refractive index. Thus, a low refractive index and high heat resistance can be achieved.

The repeating units represented by formula (3) above are preferably repeating units derived from 4,4′-(3,3,5-trimethylcyclohexylidene)bisphenol (hereinafter sometimes referred to as BisTMC), 4,4′-cyclohexylidene bisphenol (hereinafter sometimes referred to as BisZ), or 4,4′-(3-methylcyclohexylidene) bisphenol (hereinafter sometimes referred to as Bis3MZ), and more preferably repeating units derived from BisTMC.

The thermoplastic resin of the present invention may contain 20 mol % or more, 25 mol % or more, 30 mol % or more, 35 mol % or more, or 40 mol % or more of the repeating units represented by formula (3) above, and may contain 50 mol % or less, 45 mol % or less, 40 mol % or less, 35 mol % or less, or 30 mol % or less of the repeating units represented by formula (3) above. The thermoplastic resin of the present invention can contain preferably 20 mol % to 50 mol %, more preferably 25 mol % to 50 mol %, further preferably 25 mol % to 45 mol %, and particularly preferably 30 mol % to 45 mol % of the repeating units of formula (3) above.

By including the repeating units of formula (3) at the upper limit or less, a low birefringence can be achieved, and by including the repeating units of formula (3) at the lower limit or higher, a low refractive index, a low Abbe number, and a high heat resistance can be achieved.

The thermoplastic resin of the present invention may contain repeating units other than the repeating units represented by formula (1), formula (2), and formula (3) as long as the advantageous effects of the present invention described above can be obtained. Examples of dihydroxy compounds which provide such repeating units include ethylene glycol, propanediol, butanediol, pentanediol, hexanediol, heptanediol, octanediol, nonanediol, tricyclo[5.2.1.02,6]decane dimethanol, cyclohexane-1,4-dimethanol, decalin-2,6-dimethanol, norbornane dimethanol, pentacyclopentadecane dimethanol, cyclopentane-1,3-dimethanol, isosorbide, isomannide, isoidide, hydroquinone, resorcinol, 2,2-bis(4-hydroxyphenyl) propane, 2,2-bis(3-methyl-4-hydroxyphenyl) propane, 1,1-bis(4-hydroxyphenyl)-1-phenylethane, bis(4-hydroxyphenyl) diphenylmethane, 1,3-bis(2-(4-hydroxyphenyl)-2-propyl) benzene, bis(4-hydroxyphenyl) sulfone, bis(4-hydroxyphenyl) sulfide, biphenol, bisphenolfluorene, and biscresolfluorene. Such repeating units may account for 10 mol % or less of all repeating units.

The thermoplastic resin of the present invention preferably does not have phenolic hydroxyl groups at its terminals. Specifically, when the monomer which provides the repeating units represented by formula (3) above is polymerized and bonded to the terminal, the terminal group becomes a phenolic hydroxyl group. Thus, it is preferable to reduce the amount of terminal phenolic hydroxyl groups in the thermoplastic resin by, for example, using an excessive amount of a carbonic acid diester relative to the raw material dihydroxy compound during polymerization to form phenyl groups at the terminals. The ratio of terminal phenolic hydroxyl groups can be determined by:

Terminal phenolic hydroxyl group ratio=(terminal phenolic hydroxyl group amount/total terminal amount)×100

Note that all of the terminals are composed of a terminal phenolic hydroxyl group, a terminal alcoholic hydroxyl group, or a terminal phenyl group.

Though not limited to this example, the terminal phenolic hydroxyl group ratio can be specifically determined by the following method.

(1) The terminal phenolic hydroxyl group is observed by 1H NMR measurement of the thermoplastic resin, and the corresponding peak is integrated and set to 1. At the same time, the integrated intensity (A) for one proton of the fluorene structure is obtained from the integrated intensity of the peaks at positions 4 and 5 of the fluorene structure derived from formula (1) above.

Naturally, the terminal phenolic hydroxyl group ratio is 0 when no peak of the terminal phenolic hydroxyl group is observed.

(2) The average degree of polymerization of the thermoplastic resin is calculated from the number average molecular weight obtained by GPC measurement of the thermoplastic resin, the molecular weight, and mol ratio of each repeating unit, and from the mol % and the integrated intensity (A) of formula (1) above, the integrated intensity (B) in the terminal 1H NMR spectrum is obtained from the following formula.

(B)=(A)×100×2/([mol % of formula (1) above]×average degree of polymerization)

(3) The terminal phenolic hydroxyl group ratio is determined as 1/(B)×100.

The ratio of terminal phenolic hydroxyl groups to all terminals of the thermoplastic resin of the present invention is preferably 30% or less, 20% or less, 15% or less, 10% or less, 5% or less, 3% or less, 1% or less, or 0.5% or less.

### Thermoplastic Resin Properties

The refractive index of the thermoplastic resin of the present invention, when measured at a temperature of 20° C. and a wavelength of 589 nm, may be 1.510 or more, 1.515 or more, 1.520 or more, 1:525 or more, 1.530 or more, 1.535 or more, or 1.540 or more, and may be 1.570 or less, 1.565 or less, 1.560 or less, or 1.555 or less. For example, the refractive index of the thermoplastic resin of the present invention may be 1.510 to 1.570, 1.520 to 1.570, 1.520 to 1.560, or 1.530 to 1.560.

The Abbe number of the thermoplastic resin of the present invention may be 32.0 or more, 32.5 or more, 33.0 or more, 33.5 or more, or 34.0 or more, and may be 40.0 or less, 39.5 or less, 39.0 or less, 38.5 or less, 38.0 or less, 37.5 or less, or 37.0 or less. For example, the Abbe number of the thermoplastic resin of the present invention may be 32.0 to 40.0, 32.0 to 38.0, 32.0 to 37.0, or 32.0 to 36.0.

The Abbe number is calculated from the refractive indexes of 486.13 nm, 587.56 nm and 656.27 nm at a temperature of 20° C. using the following formula:

vd=(nd−1)/(nF−nC)

where nd is the refractive index at 587.56 nm,

nF is the refractive index at 486.13 nm, and

nC is the refractive index at 656.27 nm.

The specific viscosity of the thermoplastic resin of the present invention is preferably in the range of 0.12 to 0.32, and more preferably in the range of 0.18 to 0.30. When the specific viscosity is 0.12 to 0.32, the balance between moldability and strength is excellent.

Regarding the method for measuring the specific viscosity, the specific viscosity (ηSP) of a solution of 0.7 g of thermoplastic resin dissolved in 100 ml of methylene chloride is measured at 20° C. with an Ostwald viscometer, and the specific viscosity is calculated using the following formula.

Specific viscosity (ηSP)=(t−t0)/t0

where t0 is the number of seconds the methylene chloride falls, and t is the number of seconds the sample solution fills.

The absolute value of the orientation birefringence (Δn) of the thermoplastic resin of the present invention is preferably 6.0×10⁻³ or less, more preferably 5.5×10⁻³ or less, thither preferably 5.0×10⁻³ or less, and preferably 4.5×10⁻³ or less.

When the orientation birefringence is the above value or less, chromatic aberration is not significantly impacted, whereby performance as optically designed can be maintained. The orientation birefringence (Δn) is measured at a wavelength of 589 nm after stretching a 100 μm thick cast film obtained from the thermoplastic resin to 2-fold at Tg+10° C.

The thermoplastic resin of the present invention preferably has a total light transmittance of 80% or more, more preferably 85% or more, and further preferably 88% or more at a thickness of 1 mm.

The saturated water absorption rate of the thermoplastic resin of the present invention may be 0.10% or more, 0.15% or more, 0.20% Of more, 0.25% or more, or 0.30% or more, and may be 0.70% or less, 0.65% or less, or 0.60% or less. For example, the saturated water absorption rate of the thermoplastic resin of the present invention may be 0.10% to 0.70%, 0.20% to 0.70%, or 0.30% to 0.65%.

The glass transition temperature of the thermoplastic resin of the present invention may be 130° C. or higher, 135° C. or higher, 140° C. or higher, or 145° C. or higher, and may be 160° C. or lower, 155° C. or lower, or 150° C. or lower. The glass transition temperature of the thermoplastic resin of the present invention is preferably 130° C. to 160° C., more preferably 135° C. to 160° C., further preferably 135° C. to 155° C., and particularly preferably 140° C. to 155° C.

Examples of the thermoplastic resin of the present invention include a polycarbonate having a carbonate structure containing repeating units represented by formula (1), formula (2), and formula (3), and a polyester carbonate containing repeating units represented by formula (1), formula (2) and formula (3) and ester structures other than these in the repeating units thereof. Among these, polycarbonate is preferable from the point of view of heat and humidity resistance.

### Polycarbonate Resin Production Method

The polycarbonate resin of the present invention is produced by reaction means which itself is known for the production of conventional polycarbonate resins, for example, a method of reacting a dihydroxy compound with a carbonate precursor such as a carbonic acid diester. Next, the basic means of these production methods will be briefly described.

The transesterification reaction using a carbonic acid diester as a carbonate precursor is carried out by a method in which a predetermined proportion of the dihydroxy component and the carbonic acid diester are heated and stirred under an inert gas atmosphere to distill off the resulting alcohol or phenol. Though the reaction temperature differs depending on the boiling point of the alcohol or phenol to be produced, it is generally in the range of 120 to 300° C. The reaction is completed under reduced pressure from the initial stage while the produced alcohol or phenols are distilled off. Furthermore, a terminal terminator or an antioxidant may be added as needed.

Examples of carbonic acid diesters used in the transesterification reaction include esters such as optionally substituted C₆₋₁₂ aryl groups and aralkyl groups. Specific examples include diphenyl carbonate, ditolyl carbonate, bis(chlorophenyl) carbonate, and m-cresyl carbonate. Among these, diphenyl carbonate is particularly preferred. The amount of diphenyl carbonate used is preferably 0.95 to 1.10 mol, and more preferably 0.98 to 1.04 mol, per mol of the total dihydroxy compound.

In the melt polymerization method, a polymerization catalyst can be used to increase the polymerization rate, and examples of such a polymerization catalyst include alkali metal compounds, alkaline earth metal compounds, and nitrogen-containing compounds.

As such compounds, organic acid salts, inorganic salts, oxides, hydroxides, hydrides, alkoxides, and quaternary ammonium hydroxides of alkali metals and alkaline earth metals are preferably used, and these compounds can be used alone or in combination.

Examples of alkali metal compounds include sodium hydroxide, potassium hydroxide, cesium hydroxide, lithium hydroxide, sodium hydrogen carbonate, sodium carbonate, potassium carbonate, cesium carbonate, lithium carbonate, sodium acetate, potassium acetate, cesium acetate, lithium acetate, sodium stearate, potassium stearate, cesium stearate, lithium stearate, sodium borohydride, sodium benzoate, potassium benzoate, cesium benzoate, lithium benzoate, disodium hydrogen phosphate, dipotassium hydrogen phosphate, dilithium hydrogen phosphate, disodium phenyl phosphate, bisphenol A disodium, dipotassium, dicesium, and dilithium salts, and phenol sodium, potassium cesium, and lithium salts.

Examples of alkali earth metal compounds include magnesium hydroxide, calcium hydroxide, strontium hydroxide, barium hydroxide, magnesium carbonate, calcium carbonate, strontium carbonate, barium carbonate, magnesium diacetate, calcium diacetate, strontium diacetate, and barium diacetate.

Examples of nitrogen-containing compounds include quaternary ammonium hydroxides having an alkyl or aryl group such as tetramethylammonium hydroxide, tetraethylammonium hydroxide, tetrapropyl ammonium hydroxide, tetrabutylammonium hydroxide, and trimethyl benzylammonium hydroxide. Additional examples include bases or basic salts such as tetramethylammonium borohydride, tetrabutylammonium borohydride, tetrabutylammonium tetraphenylborate, and tetraphenyl ammonium tetraphenylborate.

Examples of other transesterification catalysts include salts of zinc, tin, zirconium, lead, titanium, germanium, antimony, and osmium, and for example, zinc acetate, zinc benzoate, zinc 2-ethylhexanoate, tin(II) chloride, tin(IV) chloride, tin(II) acetate, tin(IV) acetate, dibutyltin dilaurate, dibutyltin oxide, dibutyltin dimethoxide, zirconium acetyacetonate, zirconium oxyacetate, zirconium tetrabutoxide, lead(II) acetate, lead(IV) acetate, and titanium(IV) tetrabutoxide can be used. The catalysts used in WO 2011/010741 and Japanese Unexamined Patent Publication (Kokai) No. 2017-179323 may be used.

Further, a catalyst comprising aluminum or a compound thereof and a phosphorus compound may be used. In that case, the catalyst can be used at 8×10⁻⁵ mol or more, 9×10⁻⁵ mol or more, or 1×10⁻⁴ mol or more, and 1×10⁻³ mol or less, 8×10⁴ mol or less, or 6×10⁻⁴ mol or less per mol of total monomer units used.

Examples of aluminum salts include organic acid salts and inorganic acid salts of aluminum. Examples of organic acid salts of aluminum include carboxylates of aluminum, and specific examples thereof include aluminum formate, aluminum acetate, aluminum propionate, aluminum oxalate, aluminum acrylate, aluminum laurate, aluminum stearate, aluminum benzoate, aluminum trichloroacetate, aluminum lactate, aluminum citrate, and aluminum salicylate. Examples of inorganic acid salts of aluminum include aluminum chloride, aluminum hydroxide, aluminum hydroxychloride, aluminum carbonate, aluminum phosphate, and aluminum phosphonate. Examples of aluminum chelate compounds include aluminum acetylacetonate, aluminum acetylacetate, aluminum ethylacetoacetate, and aluminum ethylacetoacetate diiso-propoxide.

Examples of phosphorus compounds include phosphonic acid-based compounds, phosphinic acid-based compounds, phosphine oxide-based compounds, phosphonous acid-based compounds, phosphinous acid-based compounds, and phosphine-based compounds. Among these, phosphonic acid-based compounds, phosphinic acid-based compounds, and phosphine oxide-based compounds are preferable, and phosphonic acid-based compounds are particularly preferable.

The amount of these polymerization catalysts used is preferably 0.1 μmol to 500 μmol, more preferably 0.5 μmol to 300 μmol, and further preferably 1 μmol to 100 μmol per mol of the dihydroxy component.

Furthermore, a catalyst deactivator can be added in a Latter stage of the reaction. As the catalyst deactivator to be used any of known catalyst deactivators can effectively be used, and among these, ammonium salts and phosphonium salts of sulfonic acid are preferable. Salts of dodecylbenzenesulfonic acid such as tetrabutylphosphonium dodecylbenzenesulfonate and salts of p-toluenesulfonic acid such as tetrabutylammonium-p-toluenesulfonate are further preferred.

As the ester of sulfonic acid, methyl benzenesulfonate, ethyl benzenesulfonate, butyl benzenesulfonate, octyl benzenesulfonate phenyl benzenesulfonate, methyl p-toluenesulfonate, ethyl p-toluenesulfonate, butyl p-toluenesulfonate, octyl p-toluenesulfonate, or phenyl p-toluenesulfonate is preferably used. Among these, a dodecylbenzenesulfonic acid tetrabutylphosphonium salt is most preferably used.

When at least one polymerization catalyst selected from alkali metal compounds and/or alkaline earth metal compounds is used, the catalyst deactivator can be used preferably in a proportion of 0.5 to 50 mol, more preferably in a proportion of 0.5 to 10 mol, and further preferably in a proportion of 0.8 to 5 mol per mol of the catalyst.

### Polyester Carbonate Resin Production Method

The thermoplastic resin of the present invention may be a polyester carbonate resin. The polyester carbonate resin is produced by a reaction means itself known for the production of conventional polyester carbonate resins, for example, a method of subjecting a dihydroxy compound to a polycondensation reaction of a carbonate precursor such as a carbonic acid diester and a dicarboxylic acid or an ester-forming derivative thereof.

In the reaction of a dihydroxy compound, dicarboxylic acid, or an acid chloride thereof with phosgene, the reaction is carried out in a non-aqueous system in the presence of an acid binder and a solvent. Examples of acid binders include pyridine, dimethylaminopyridine, and tertiary amines. Halogenated hydrocarbons such as methylene chloride and chlorobenzene can be used as the solvent. As a molecular weight modifier, it is desirable to use a terminal terminator such as phenol or p-tert-butylphenol. The reaction temperature is conventionally 0 to 40° C., and the reaction time is preferably several minutes to 5 hours.

In the transesterification reaction, a dihydroxy compound, a dicarboxylic acid, or a diester thereof and a bisaryl carbonate are mixed under an inert gas atmosphere and reacted under reduced pressure at conventionally 120 to 350° C., and preferably 150 to 300° C. The degree of pressure reduction is changed stepwise, and the pressure is ultimately reduced to 133 Pa or less to distill the produced alcohols out of the system. The reaction time is conventionally approximately 1 to 4 hours. In the transesterification reaction, a polymerization catalyst can be used in order to promote the reaction. As such a polymerization catalyst, it is preferable to use an alkali metal compound, an alkaline earth metal compound, or a heavy metal compound as a main component and, if necessary a nitrogen-containing basic compound as an auxiliary component.

Examples of alkali metal compounds include sodium hydroxide, potassium hydroxide, lithium hydroxide, sodium hydrogen carbonate, potassium hydrogen carbonate, lithium hydrogen carbonate, sodium, carbonate, potassium carbonate, lithium carbonate, sodium acetate, potassium acetate, lithium acetate, sodium stearate, potassium stearate, lithium stearate, bisphenol A sodium, potassium and lithium salts, sodium benzoate, potassium benzoate, and lithium benzoate. Examples of alkaline earth metal compounds include calcium hydroxide, barium hydroxide, magnesium hydroxide, strontium hydroxide, calcium hydrogen carbonate, barium hydrogen carbonate, magnesium hydrogen carbonate, strontium hydrogen carbonate, calcium carbonate, barium carbonate, magnesium carbonate, strontium carbonate, calcium acetate, barium acetate, magnesium acetate, strontium acetate, calcium stearate, barium stearate, magnesium stearate, and strontium stearate.

Examples of nitrogen-containing basic compounds include tetramethylammonium hydroxide, tetraethylammonium hydroxide, tetrabutylammonium hydroxide, trimethylbenzylammonium hydroxide, trimethylamine, triethylamine, dimethylbenzylamine triphenylamine, and dimethylaminopyridine.

As other transesterification catalysts, the catalysts exemplified as transesterification catalysts in the method for producing a polycarbonate described above can likewise be used.

When the thermoplastic resin of the present invention is a polyester carbonate, the catalyst may be removed or deactivated after the completion of the polymerization reaction in order to maintain thermal stability and hydrolytic stability. In general, a method for deactivating the catalyst by adding a known acidic substance is preferably carried out. As these substances, specifically, esters such as butyl benzoate, aromatic sulfonic acids such as p-toluenesulfonic acid, aromatic sulfonate esters such as butyl p-toluenesulfonate and hexyl p-toluenesulfonate, phosphoric acids such as phosphorous acid, phosphoric acid, and phosphonic acid, phosphite esters such as triphenyl phosphite, monophenyl phosphite, diphenyl phosphite, diethyl phosphite, di-n-propyl phosphite, di-n-butyl phosphite, di-n-hexyl phosphite, dioctyl phosphite, and monooctyl phosphite, phosphoric esters such as biphenyl phosphate, diphenyl phosphate, monophenyl phosphate, dibutyl phosphate, dioctyl phosphate, and monooctyl phosphate, phosphoric acids such as diphenylphosphonic acid, dioctylphosphonic acid, and dibutylphosphonic acid, phosphonic esters such as diethyl phenylphosphonate, phosphines such as triphenylphosphine and bis(diphenylphosphino)ethane, boric acids such as boric acid and phenylboric acid, aromatic sulfonates such as dodecylbenzenesulfonate tetrabutylphosphonium salts, organic halides such as stearic acid chloride, benzoyl chloride, and p-toluenesulfonic acid chloride, alkyl sulfates such as dimethyl sulfate, and organic halides such as benzyl chloride can suitably be used. These deactivators are used in an amount of )0.01 to 50-fold mol, and preferably 0.3 to 20-fold mol, relative to the amount of the catalyst. When this amount is less than 0.01-fold mol relative to the molar amount of the catalyst, the deactivation effect becomes insufficient, which is not preferable. Conversely, when it is more than 50-fold mol relative to the molar amount of the catalyst, the heat resistance is reduced and the molded article tends to be discolored, which is not preferable.

After deactivating the catalyst, a step of devolatilizing and removing low boiling point compounds in the thermoplastic resin at a pressure of 13.3 to 133 Pa and a temperature of 200 to 320° C. may be provided.

### Thermoplastic Resin Composition

Any of additives such as release agents, heat stabilizers, UV absorbers, bluing agents, antistatic agents, flame retardants, plasticizers, fillers, antioxidants, light stabilizers, polymerized metal deactivators, lubricants, surfactants, and antibacterial agents can be appropriately added to the thermoplastic resin of the present invention as needed for use as a resin composition. As specific release agents and heat stabilizers, those described in WO 2011/010741 are preferable.

As particularly preferable release agents, stearic monoglyceride, stearic triglyceride, pentaerythritol tetrastearate, and a mixture of stearic triglyceride and stearyl stearate are preferably used. The amount of the ester in the release agent is preferably 90% by weight or more, and more preferably 95% by weight or more, relative to 100% by weight of the release agent. The release agent to be mixed with the thermoplastic resin is preferably in the range of 0.005 to 2.0 parts by weight, more preferably in the range of 0.01 to 0.6 parts by weight, and further preferably in the range of 0.02 to 0.5 parts by weight relative to 100 parts by weight of the thermoplastic resin.

Examples of thermal stabilizers include phosphorus-based thermal stabilizers, sulfur-based thermal stabilizers, and hindered phenol-based thermal stabilizers.

As particularly preferable phosphorus-based heat stabilizers, tris(2,4-di-tert-butylphenyl) phosphite, bis(2,6-di-tert-butyl-4-methylphenyl)pentaerythritol diphosphite, and tetrakis(2,4-di-tert-butylphenyl)-4,4′-biphenylenediphosphonite can be used. The content of the phosphorus-based heat stabilizer in the polycarbonate resin is preferably 0.001 to 0.2 parts by weight relative to 100 parts by weight of the thermoplastic resin.

Pentaerythritol-tetrakis(3-laurylthiopropionate) is a particularly preferably sulfur-based heat stabilizer. The content of the sulfur-based heat stabilizer in the thermoplastic resin is preferably 0.001 to 0.2 parts by weight relative to 100 parts by weight of the thermoplastic resin.

Examples of preferably hindered phenol-based heat stabilizer include octadecyl-3-(3,5-di-tert-butyl-4-hydroxyphenyl)propionate and pentaerythritol-tetrakis[3-(3,5-di-tert-butyl-4-hydroxyphenyl)propionate].

The content of the hindered phenol-based heat stabilizer in the thermoplastic resin is preferably 0.001 to 0.3 parts by weight relative to 100 parts by weight of the thermoplastic resin.

A phosphorus-based heat stabilizer and a hindered phenol-based heat stabilizer can also be used together.

As the UV absorber, at least one UV absorber selected from the group consisting of benzotriazole UV absorbers, benzophenone UV absorbers, triazine UV absorbers, cyclic imino ester UV absorbers, and cyanoacrylate UV absorbers is preferable.

In benzotriazole-based UV absorbers, 2-(2-hydroxy-5-tert-octylphenyl)benzotriazole and 2,2′-methylenebis[4-(1,1,3,3-tetramethylbutyl)-6-(2H-benzotriazol-2-yl)phenol] are more preferable.

Examples of benzophenone-based UV absorbers include 2-hydroxy-4-n-dodecyloxybenzophenone and 2-hydroxy-4-methoxy-2′-carboxybenzophenone.

Examples of triazine-based UV absorbers include 2-(4,6-diphenyl-1,3,5-triazin-2-yl)-5-[(hexyl)oxy]-phenol and 2-(4,6-bis(2,4-dimethylphenyl)-1,3,5-triazin-2-yl)-5-[(octyl)oxy]-phenol.

2,2′-p-phenylenebis(3,1-benzoxazin-4-one) is particularly suitable as the cyclic imino ester-based ultraviolet absorber.

Examples of cyanoacrylate-based UV absorbers include 1,3-bis-[(2′-cyano-3′, 3′-diphenylacryloyl)oxy]-2,2-bis[(2-cyano-3,3-diphenylacryloyl)oxy]methyl)propane and 1,3-bis-[(2-cyano-3,3-diphenylacryloyl)oxy]benzene.

The compounding amount of the ultraviolet absorber is preferably 0.01 to 3.0 parts by weight relative to 100 parts by weight of the thermoplastic resin, and when the compounding amount is within such a range, it is possible to impart sufficient weather resistance to thermoplastic resin molded articles depending on the application.

Examples of antioxidants include triethylene glycol-bis[3-(3-tert-butyl-5-methyl-4-hydroxyphenyl)propionate], 1,6-hexanediol-bis[3-(3,5-di-tert-butyl-4-hydroxphenyl)propionate], pentaerythritol-tetrakis[3-(3,5-di- tert-butyl-4-hydroxyphenyl)propionate], octadecyl-3-(3,5-di-tert-butyl-4-hydroxyphenyl)propionate, 1,3,5-trimethyl-2,4,6-tris(3,5-di-tert-butyl-4-hydroxybenzyl)benzene, N,N hexamethylenebis(3,5-di-tert-butyl-4-hydroxy-hydrocinnamide), 3,5-di-tert-butyl-4-hydroxy-benzylphosphonate-diethyl ester, tris(3,5-di-tert-butyl-4-hydroxybenzyl) isocyanurate, and 3,9-bis{1,1-dimethyl-2-[β-(3-tert-butyl-4-hydroxy-5-methylphenyl)propionyloxy]ethyl}-2,4,8,10-tetraoxaspiro (5,5)undecane. The compounding amount of the antioxidant is preferably 0.50 parts by mass or less, more preferably 0.05 to 0.40 parts by mass, further preferably 0.05 to 0.20 parts by mass or 0.10 to 0.40 parts by mass, and particularly preferably 0.20 to 0.40 parts by mass relative to 100 parts by mass of the thermoplastic resin composition.

### Optical Member

The optical member of the present invention comprises the thermoplastic resin described above. Such optical member is not particularly limited as long as it used in optical applications where the above thermoplastic resin is useful, and examples thereof include optical discs, transparent conductive substrates, optical cards, sheets, films, optical fibers, lenses, prisms, optical films, substrates, optical filters, and hard coat films.

The optical member of the present invention may be composed of a resin composition containing the thermoplastic resin described above, and additives such as heat stabilizers, plasticizers, light stabilizers, polymeric metal deactivators, flame retardants, lubricants, antistatic agents, surfactants, antibacterial agents, UV absorbers, release agents, bluing agents, fillers, and antioxidants can be included in the resin composition as needed.

### Optical Lens

As the optical member of the present invention, an optical lens is particularly preferable. Examples of such optical lenses include imaging lenses for mobile phones, smartphones, tablet terminals, personal computers, digital cameras, video cameras, in-vehicle cameras, and surveillance cameras, and sensing cameras such as TOF cameras.

When the optical lens of the present invention is produced by injection molding, it is preferable to carry out molding under the conditions of a cylinder temperature of 230 to 350° C. and a mold temperature of 70 to 180° C. Molding is more preferably carried out under the conditions of a cylinder temperature of 250 to 300° C. and a mold temperature of 80 to 170° C. When the cylinder temperature is higher than 350° C. the thermoplastic resin is decomposed and discolored, and when it is lower than 230° C., the melt viscosity tends to be high, making molding difficult. When the mold temperature is higher than 180° C., it tends to be difficult to remove the molded article composed of the thermoplastic resin from the mold. Conversely, when the mold temperature is less than 70° C., the resin tends to harden too quickly in the mold during molding, making it difficult to control the shape of the molded article, and it tends to be difficult to sufficiently transfer the imprint applied to the mold.

The optical lens of the present invention can suitably be implemented in the form of an aspherical lens as needed. Since aspherical lenses can eliminate spherical aberration with a single lens, there is no need to combine multiple spherical lenses to remove spherical aberration, which can help reduce weight and molding costs. Thus, aspherical lenses are particularly useful as camera lenses among optical lenses.

Since the thermoplastic resin of the present invention has high molding fluidity, it is particularly useful as a material for optical lenses that are thin, small, and have complicated shapes. As a specific lens size, the thickness of the central portion is 0.05 to 3.0 mm, more preferably 0.05 to 2.0 mm, and further preferably 0.1 to 2.0 mm. The diameter is 1.0 mm to 20.0 mm more preferably 1.0 to 10.0 mm, and further preferably 3.0 to 10.0 mm. It is preferable that the lens be a meniscus lens having a convex surface on one side and a concave surface on the other side.

A lens composed of the thermoplastic resin of the present invention can be molded by any method such as mold molding, cutting, polishing, laser processing, electrical discharge machining. or etching. Among these, mold molding is more preferable from the viewpoint of production cost.

The present invention will be described more specifically by the following Examples, but the present invention is not limited thereto.

### EVALUATION METHODS

### Thermoplastic Resin Composition

1H NMR measurement with a JNM-ECZ400S manufactured by JEOL is carried out and the composition ratio of each thermoplastic resin is calculated.

### Glass Transition Temperature

Obtained thermoplastic resins are measured with a Discovery DSC25 Auto model manufactured by TA Instruments Japan Co., Ltd., at a temperature increase rate of 20° C./min. Samples are measured at 5 to 10 mg.

### Refractive Index

After preparing and polishing a 3 mm-thick test sample of each thermoplastic resin, the refractive index (587.56 nm) is measured using a Calnew precision refractometer KPR-2000 manufactured by Shimadzu Corporation.

### Abbe Number

The Abbe number is calculated from the refractive indexes of 486.13 nm, 587.56 nm and 656.27 nm using the following formula:

vd=(nd−1)/(nF−nC)

where nd: refractive index at a wavelength of 587.56 nm,

nF: refractive index at a wavelength of 486.13 nm, and

nC: the refractive index at a wavelength of 656.27 nm.

### Absolute Value of Orientation Birefringence

The thermoplastic resin is dissolved in methylene chloride, then cast on a glass petri dish, and sufficiently dried to prepare a cast film having a thickness of 100 μm. The film is stretched 2-fold at Tg+10° C., the phase difference (Re) at 589 nm is measured using an ellipsometer M-220 manufactured by JASCO Corporation, and the absolute value of orientation birefringence (|Δn|) is calculated from the following formula:

|Δn|=|Re/d|

where Δn: orientation birefringence,

Re: phase difference (nm), and

d: thickness (nm)

### Water Absorption Rate

A plate-shaped molded article obtained by injection molding is measured in accordance with ISO62.

### Evaluation of Lens Optical Distortion

At a cylinder temperature of 270° C. and a mold temperature of 115° C., an aspherical lens having a thickness of 0.2 mm, a convex curvature radius of 5 mm, a concave curvature radius of 4 mm, and a diameter of 5 mm is injection molded using an SE30DU injection molding machine manufactured by Sumitomo Heavy Industries, Ltd. Optical distortion is evaluated by interposing the aspherical lens between two polarizing plates and visually observing light leakage by the crossed Nicols method. Evaluation is carried out in accordance with the following criteria.

A: Substantially no light leakage

B: Slight light leakage is observed

C: There is light leakage

F: Significant light leakage

### EXAMPLES

### Example 1

21.93 g (0.05 mol) of 9,9-bis[4-(2-hydroxyethoxy)phenyl]fluorene (BPEF), 173.50 g (0.57 mol) of 3,9-bis(2-hydroxy-1,1-dimethylethyl)-2,4,8,10-tetraoxaspiro(5,5)undecane (SPG), 117.95 g (0.38 mol) of 4,4′-(3,3,5-trimethylcyclohexylidene)bisphenol (BisTMC), 218.50 g (1.02 mol) of diphenyl carbonate, and as a catalyst, 0.125 mL of a sodium hydrogen carbonate aqueous solution having a concentration of 40 mmol/L (5.0 μmol of sodium hydrogen carbonate) and 0.109 mL of a 274 mmol/L tetramethylammonium hydroxide aqueous solution (30 μmol of tetramethylammonium hydroxide) were heated to 180° C. in a nitrogen atmosphere for melting. Thereafter, the degree of pressure reduction was adjusted to 20 kPa over 10 minutes. The temperature was increased to 250° C. at a rate of 60° C./h, and after the outflow of phenol reached 70%, the internal pressure of the reactor was brought to 133 Pa or less over 1 hour. The reaction was carried out by stirring for a total of 3.5 hours, and after completion of the reaction, the resin was removed from the flask. The composition ratio of the obtained polycarbonate resin was measured by NMR.

### Examples 2 to 10

Polycarbonate resins were produced in the same manner as Example 1 except that the composition ratio of BPEF, SPG, and BisTMC and the monomer ratios were changed so as to achieve the ratios shown in Table 1.

### Results

The structures and evaluation results of each of the Examples and Comparative Examples are summarized in Table 1 below.

TABLE 1

| | Example | | | | | | | | | |
|---|---|---|---|---|---|---|---|---|---|---|
| | 1 | 5 | 3 | 4 | 5 | 6 | 7 | 8 | 9 | 10 |
| BPEF (mol %) | 5 | 12 | 10 | 17 | 15 | 15 | 20 | 24 | 30 | 30 |
| SPG (mol %) | 57 | 57 | 53 | 53 | 45 | 37 | 45 | 47 | 43 | 35 |
| BisTMC (mol %) | 38 | 31 | 37 | 35 | 40 | 48 | 35 | 29 | 27 | 35 |
| Refractive index | 1.520 | 1.529 | 1.529 | 1.532 | 1.540 | 1.545 | 1.546 | 1.549 | 1.558 | 1.563 |
| Abbe number | 39.1 | 37.6 | 37.6 | 37.2 | 35.9 | 35.1 | 34.9 | 34.4 | 33 | 32.3 |
| Δn × 10⁻³ | 5.6 | 4.7 | 5.2 | 4.9 | 5.0 | 5.5 | 4.4 | 3.8 | 3.4 | 3.8 |
| Tg (° C.) | 140 | 136 | 142 | 141 | 147 | 156 | 145 | 140 | 141 | 149 |
| Saturated water | 0.55 | 0.55 | 0.50 | 0.55 | 0.50 | 0.55 | 0.45 | 0.45 | 0.50 | 0.50 |
| absorption rate | | | | | | | | | | |
| (%) | | | | | | | | | | |
| Lens optical | C | B | C | B | B | C | A | A | A | A |
| distortion | | | | | | | | | | |

### INDUSTRIAL APPLICABILITY

The thermoplastic resin of the present invention can be used in optical materials, can be used in optical members such as optical lenses, prisms, optical disks, transparent conductive substrates, optical cards, sheets, films, optical fibers, optical films, optical filters, and hard coat films, and in particular, is very useful for optical lenses.

1. A thermoplastic resin containing repeating units represented by formula (1), formula (2), and formula (3), and having a refractive index of 1.510 to 1.570: 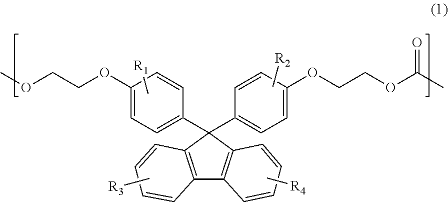
where R₁, R₂, R₃, and R₄ each independently represent a hydrogen atom or a C₁₋₁₀ hydrocarbon group; 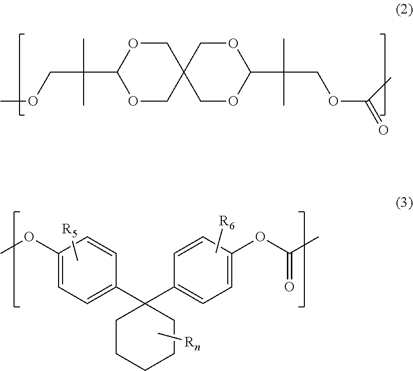
where n is in the range of 1 to 8, each R is independently selected from a hydrogen atom and a C₁₋₃ alkyl group, R₅ and R₆ each independently represent a hydrogen atom or a C₁₋₁₀ hydrocarbon group.

2. The thermoplastic resin according to claim 1, having an Abbe number of 32.0 to 40.0.

3. The thermoplastic resin according to claim 1, having a saturated water absorption rate of 0.1% to 0.7%.

4. The thermoplastic resin according to claim 1, having a glass transition temperature of 130° C. to 160° C.

5. The thermoplastic resin according to claim 1, having an orientation birefringence of 6×10⁻³ or less.

6. The thermoplastic resin according to claim 1, wherein the repeating units of formula (1) are contained at 1 mol % to 40 mol %.

7. The thermoplastic resin according to claim 1, wherein the repeating units of formula (2) are contained at 30 mol % to 60 mol %.

8. The thermoplastic resin according to claim 1, wherein the repeating units of formula (3) are contained at 20 mol % to 50 mol %.

9. An optical member, comprising the thermoplastic resin according to claim 1.
